(19) United States
(12) Patent Application Publication
(10) Pub. No.: US 2026/0152443 A1
(43) Pub. Date: Jun. 4, 2026

(54) FIBROUS PREFORM AND METHOD FOR MANUFACTURING SAME TO PRODUCE A PART MADE OF A COMPOSITE MATERIAL HAVING A CERAMIC MATRIX

(71) Applicant: SAFRAN CERAMICS, LE HAILLAN (FR)

(72) Inventors: Simon Lucien René THIBAUD, MOISSY-CRAMAYEL (FR); Jean-François HENNE, MOISSY-CRAMAYEL (FR); Adrien DELCAMP, MOISSY-CRAMAYEL (FR); Manon FERNANDEZ, MOISSY-CRAMAYEL (FR); Benjamin COSSOU, MOISSY-CRAMAYEL (FR)

(73) Assignee: SAFRAN CERAMICS, LE HAILLAN (FR)

(21) Appl. No.: 19/122,932

(22) PCT Filed: Oct. 11, 2023
(86) PCT No.: PCT/FR2023/051578

§ 371 Date: Apr. 21, 2025

(30) Foreign Application Priority Data
Oct. 21, 2022 (FR) FR2210914

(51) Int. Cl. C04B 35/80; C04B 35/628; C04B 35/657

(52) U.S. Cl. CPC C04B 35/80; C04B 35/62863; C04B 35/62868; C04B 35/62878; C04B 35/62884; C04B 35/62892; C04B 35/62897; C04B 35/657; C04B 2235/3826; C04B 2235/386; C04B 2235/5244; C04B 2235/5252; C04B 2235/614; C04B 2235/616; C04B 2235/785

(57) ABSTRACT

A fibrous preform for producing a part made of ceramic matrix composite material. The fibrous preform can include:
a fibrous reinforcement having fibers based on silicon carbide;
an interphase layer extending around a surface of each of the fibers based on silicon carbide, wherein the interphase layer can be based on boron nitride;
a pre-densified layer of silicon carbide located on the interphase layer and having a columnar microstructure, the pre-densified layer having a thickness of between 3 μm and 20 μm; and
a sacrificial layer located on said pre-densified layer, the sacrificial layer being formed from silicon carbide having an average grain size of between 0.1 μm and 0.5 μm.

### Technical Field

The invention relates to the general field of manufacturing parts made of composite material having a ceramic matrix, in particular based on silicon carbide. More particularly, the invention relates to a fibrous preform for producing a part made of a composite material having a ceramic matrix. The invention also relates to a method of manufacturing such a fibrous preform and such a part made of composite material having a ceramic matrix.

### TECHNICAL BACKGROUND

The prior art comprises especially the documents US-A1-2016/107940, US-A1-2014/363663, US-A1-2016/159702, US-B2-8 039 053 and EP-A1-3 957 619.

The ceramic matrix composites (CMC) materials have good thermo-structural properties, i.e. high mechanical properties that make them suitable for structural parts and the ability to retain these properties at high temperatures (in particular up to 1200° C. and even higher) and in an oxidising environment.

The use of CMC materials instead of metallic materials is advantageous in the aeronautical field, such as in the aircraft turbomachines. Indeed, these CMC materials are relatively light compared with metallic materials and are suitable for use at higher temperatures than the latter.

Generally speaking, a CMC material is a ceramic matrix in which ceramic fibers (or filaments) are embedded. The CMC material can be carbide-based, such as silicon carbide (SIC) fibers or carbon (C) fibers which can be reinforced with a silicon carbide matrix, or any other non-oxide ceramic fibrous reinforcement with a non-oxide ceramic matrix.

A method for manufacturing CMC materials, in particular those reinforced with silicon carbide-based fibers, comprises producing a fibrous preform whose shape is close to that of the part to be manufactured, followed by densification of this fibrous preform by a matrix.

FIG. 1 shows an example of a method for producing a part in CMC material. To achieve this, the method comprises the following steps:
(a) producing a fibrous reinforcement 2 comprising fibers 20 of silicon carbide,
(b) coating the fibers 20 of the fibrous reinforcement with an interphase layer 3,
(c) forming a so-called pre-densified layer 4 of silicon carbide on the interphase layer 3 by chemical vapour infiltration (CVI) to form a fibrous preform 1,
(e) incorporating a silicon carbide powder in the pores of the fibrous preform 1,
(f) densifying the fibrous preform 1 obtained in step (e) by melt infiltration (MI) of a ceramic matrix 6, in particular with liquid silicon, to form the part made of CMC material.

The fibrous preform 1 formed in step (c) therefore comprises:
the fibrous reinforcement 2 comprising silicon carbide-based fibers 20,
the interphase layer 3 surrounding a surface 22 of the fiber 20,
the pre-densified layer 4 at least partially encapsulating the interphase layer 3.

The interphase layer 3 may be based on boron nitride (BN). The interphase layer 3 coating the fibers 20 optimises the bond between the fibers 20 and the matrix 6 of the part made from CMC material. Indeed, this interphase layer 3 provides a sufficient bond to ensure that the mechanical stresses to which the part made of CMC material is subjected are transferred to the fibrous reinforcement. The interphase layer 3 thus deflects the cracks generated within the matrix 6.

The silicon carbide in the pre-densified layer 4 has a microstructure composed of grains that grow in a preferred direction during CVI deposition to form a columnar microstructure of silicon carbide. In such a columnar microstructure, the largest dimension of the grains is their radial dimension, i.e. that extending between the fiber 20 and the outer surface of the pre-densified layer 4. This pre-densified layer 4 also protects the fibers 20 and the interphase layer 3 by consolidating them in a predefined shape through a first level of densification.

The incorporation of silicon carbide powder 5 limits the reactivity of the liquid silicon on the pre-densified layer 4 during step (f). The powder mixture 5 also allows to fractionate the porosity of the fibrous preform 1 to facilitate the capillary rise of the liquid silicon in this fibrous preform 1 during step (f).

Finally, the melt infiltration technique provides a second level of densification to plug the porosity of the fibrous preform 1. Step (f) allows to densify and form the part made from CMC material, while also protecting the fibers 20 and the matrix 6.

Although the chemical interaction between the liquid silicon and the pre-densified layer 4 is limited (in particular by steps (c) and (e)), the method described above is not fully satisfactory. Even in the presence of the silicon carbide powder 5, corrosion of the pre-densified layer 4 by the liquid silicon can be observed at random on the pre-densified layer. This corrosion is mainly observed at the grain boundaries of the pre-densified layer and propagates along them. Due to the columnar microstructure of the pre-densified layer, and preferential propagation along the grain boundaries, corrosion can lead to the formation of cracks extending in the radial direction of the fiber, i.e. from the free surface of the pre-densified layer to the fiber of the fibrous reinforcement. The presence of such crevices can adversely affect the mechanical properties and service life of the part made from CMC material.

These crevices are indicated by arrows in FIG. 2. They explain a deep degradation on the pre-densified layer up to the interphase layer. The liquid silicon can infiltrate between the columns of the pre-densified layer. As a result, the deposition of the pre-densified layer on the interphase layer may have limited effectiveness in protecting the interphase layer from infiltration by liquid or molten silicon.

There is therefore a need to optimise the manufacture of parts in CMC material by limiting the reactivity of liquid silicon with respect to silicon carbide deposited by CVI prior to the densification operation by MI.

### SUMMARY OF THE INVENTION

The present invention provides a simple, effective and economical solution to the aforementioned disadvantages of the prior art.

To this end, the invention relates to a fibrous preform for producing a part made of ceramic matrix composite material, the fibrous preform comprising:
a fibrous reinforcement comprising fibers based silicon carbide,
an interphase layer extending around a surface of each of said fibers based on silicon carbide, preferably the interphase layer being based on boron nitride,
a pre-densified layer comprising silicon carbide, located on the interphase layer and having a columnar microstructure, said pre-densified layer having a thickness of between 3 μm and 20 μm.

According to the invention, the fibrous preform further comprises a sacrificial layer located on said pre-densified layer, said sacrificial layer comprising silicon carbide having grains with an average size of between 0.1 μm and 0.5 μm.

A fibrous preform is an intermediate part used to produce a part made of CMC material. This fibrous preform can be said to be “pre-densified” as it has a first level of densification. Indeed, the fibrous preform comprises a layer pre-densified by a pre-densification phase of silicon carbide deposited by CVI.

The main advantage of the fibrous preform according to the invention is that it significantly enhances the protection of the pre-densified layer, the interphase layer and the fibrous reinforcement against attack by liquid silicon during the production of this fibrous preform.

To do this, the fibrous preform comprises a sacrificial layer of silicon carbide on the pre-densified layer so that this sacrificial layer, forming an outer surface of the fibrous preform, blocks degradation of the pre-densified layer (and the interphase layer and the fiber) by liquid silicon.

The term “sacrificial” refers to a portion (or zone) of this sacrificial layer that is non-functional and therefore configured to be degraded first by the liquid silicon. In particular, the sacrificial layer has a silicon carbide grain size smaller than the size of the columnar microstructure of the pre-densified layer. This allows to form a fine-grained microstructure of the sacrificial layer compared with the columnar microstructure of the pre-densified layer. The sacrificial layer is therefore enriched in carbon (compared with the pre-densified layer). Indeed, the small grain size of the sacrificial layer allows to increase the grain boundary surface in this sacrificial layer, whose carbon can react with the liquid silicon and the sacrificial layer thus protects the underlying layer (i.e. the pre-densified layer) from the reactivity of the liquid silicon. In addition, the fine-grained microstructure of the silicon carbide in the sacrificial layer creates a tortuosity (i.e. a tortuous/sinuous, labyrinth-like path) so as to limit the infiltration and propagation of liquid silicon to the layers beneath the sacrificial layer. Consequently, the fibrous preform according to the invention has very good resistance to the chemical reactivity of liquid silicon and improves the mechanical performance of the CMC material part to be made from this fibrous preform.

The sacrificial layer can be differentiated from the pre-densified layer by the shape and/or average size of the silicon carbide grains. Indeed, the pre-densified layer has a columnar microstructure (i.e. SiC grains having a columnar shape, for example substantially cylindrical or frustoconical), the largest dimension of each SiC grain being greater than or equal to 3 μm, while the sacrificial layer has grain sizes of between 0.1 and 0.5 μm (i.e. a granular microstructure with SiC grains having a more or less spherical and/or fine or flat shape, the largest dimension of each SiC grain being less than or equal to 0.5 μm). As a result, the grain size of the sacrificial layer is smaller than the columnar grain size of the pre-densified layer.

The fibrous preform may comprise one or more of the following characteristics, taken alone or in combination with each other:
said at least one sacrificial layer has a grain density greater than that of the pre-densified layer by a factor of between 20 and 40;
said at least one sacrificial layer has a thickness of between 1 and 4 μm;
several sacrificial layers are superimposed on one another and extend over said pre-densified layer, the number of these sacrificial layers being at most five;
the columnar microstructure of the pre-densified layer has SiC grains in cylindrical form, preferably with a height greater than or equal to 3 μm and/or a width of between 0.2 μm and 1 μm;
the columnar microstructure of the pre-densified layer has SiC grains in columnar form (e.g. cylindrical, frustoconical or trapezoidal, etc.) preferably having a height greater than or equal to 3 μm and/or a width of between 0.2 μm and 1 μm;
the columnar microstructure of the pre-densified layer has silicon carbide grains with a form factor strictly greater than a form factor of the silicon carbide grains of the sacrificial layer;
the form factor of the SIC grains of the pre-densified layer is greater than or equal to 10, preferably greater than or equal to 20;
the form factor of the SIC grains of the sacrificial layer is less than or equal to 5, preferably less than or equal to 2;
the pre-densified layer has a thickness of between 10 and 20 μm;
the sacrificial layer has a thickness of between 5% and 20% of the thickness of the pre-densified layer;
the interphase layer has a thickness of between 100 nm and 700 nm, preferably between 250 nm and 500 nm;
the size of the SiC grains can be a grain diameter;
the thickness of the interphase layer, the pre-densified layer and the sacrificial layer is measured by transmission electron microscopy or scanning electron microscopy;
The size of the SIC grains of the pre-densified and sacrificial layers is measured by transmission electron microscopy;
the crystalline orientation and general structure (or difference in structure) of the SiC grains in the pre-densified and sacrificial layers are determined by transmission electron microscopy or Raman spectroscopy;
the density of SIC grains of the pre-densified and sacrificial layers is measured by transmission electron microscopy TEM or Raman spectroscopy.

The form factor of a silicon carbide grain is the ratio of its largest dimension to its smallest dimension.

The invention also relates to a ceramic matrix composite material part comprising a fibrous preform according to any one of the preceding claims, and a densified ceramic matrix, said ceramic matrix preferably being based on silicon carbide.

The part made of CMC material can be a part of a turbomachine, in particular an aircraft. By way of example, this turbomachine part is a vane of a turbine or compressor of the turbomachine, an annular wall of a combustion chamber of the turbomachine, etc.

The invention also relates to a method for manufacturing a fibrous preform according to one of the characteristics of the invention. This fibrous preform is used to make a ceramic matrix composite part in accordance with the invention. This method comprises the steps consisting of:
(a) obtaining the fibrous reinforcement comprising fibers based silicon carbide,
(b) forming the interphase layer on each of the surfaces of the fibers based silicon carbide,
(c) forming the pre-densified layer on said interphase layer by chemical vapour infiltration (CVI), to obtain said fibrous preform, and
(d) depositing at least one silicon carbide-based sacrificial layer on said pre-densified layer obtained in step (c) by chemical vapour infiltration (CVI).

As mentioned previously, the sacrificial layer encapsulating the pre-densified layer of the fibrous preform prevents degradation of the pre-densified layer by the liquid silicon. To achieve this, one or more parameters of the CVI silicon carbide deposition can be changed from a columnar microstructure of the silicon carbide grains in the pre-densified layer to a crystallised microstructure of the silicon carbide grains in the sacrificial layer. In particular, the shape, size and/or density of the SiC grains can be modified by changing at least one of the parameters from among the duration of the CVI deposition, the proportion by volume of methyltrichlorosilane (MTS) and dihydrogen (H₂) in the gas mixture, the pressure, the temperature, the number of cycles and the duration of each cycle. The aim is to generate an excess of carbon in the sacrificial layer compared with the level of carbon in the pre-densified layer. The method for obtaining the fibrous preform of the invention thus allows to achieve the above-mentioned objective by modifying the parameters of an existing CVI deposition step in the method for manufacturing a CMC material part.

At the end of step (c) and step (d), the fibrous preform can be said to be “pre-densified” because a first level of densification or pre-densification of silicon carbide deposited by CVI is achieved.

The method of manufacturing the fibrous preform may comprise one or more of the following characteristics, taken alone or in combination with each other:
the chemical vapour infiltration of step (c) is carried out by a first gaseous mixture comprising methyltrichlorosilane (MTS) and dihydrogen (H₂), in a volume ratio of dihydrogen to methyltrichlorosilane of between 5 and 15 (i.e. a proportion by volume of H₂ of between 83 and 94% and a proportion by volume of MTS of between 17% and 6% respectively), at a first pressure of between 70 mbar and 150 mbar and for a first time of between 10 hours and 30 hours, and the chemical vapour infiltration of step (d) is carried out by a second gas mixture comprising methyltrichlorosilane (MTS) and dihydrogen (H₂) at a second pressure identical to the first pressure and for a second duration of between 30 minutes and 3 hours;
step (c) comprises a single cycle;
step (d) comprises at least two successive cycles, preferably between two and ten cycles, each cycle having a duration of between 3 and 18 minutes;
in step (d), the second gas mixture comprises a higher proportion of methyltrichlorosilane (MTS) than of dihydrogen (H₂), preferably the volume proportion of methyltrichlorosilane (MTS or CH₃Cl₃Si) and dihydrogen (H₂) is between 70/30 and 85/15 by volume, and wherein the first and second predetermined pressures are identical;
the method comprises a step (e) of incorporating a mixture of ceramic powders, preferably silicon carbide, into said fibrous preform obtained in step (d).

The invention also relates to a method of manufacturing a part made of a composite material having a ceramic matrix according to the invention. This method comprises steps (a) to (e) of the method for manufacturing a fibrous preform described above, and a step (f) of densifying said fibrous preform obtained in step (e) by infiltration of a molten ceramic matrix to form said part made of a composite material having a ceramic matrix.

Preferably, the ceramic matrix is based on liquid silicon.

At the end of step (f), the fibrous preform can be said to be “densified” by the ceramic matrix because a second level of densification with silicon is achieved by MI infiltration.

### BRIEF DESCRIPTION OF THE FIGURES

The invention will be better understood and other details, characteristics and advantages of the present invention will become clearer from the following description made by way of non-limiting example and with reference to the attached drawings, wherein:

FIG. 1 schematically represents a method for manufacturing a CMC material according to the prior art,

FIG. 2 shows the reactivity of liquid silicon on a pre-densified layer of silicon carbide of the CMC material obtained by the method shown in FIG. 1,

FIG. 3 is a partial schematic representation of a pre-densified fibrous preform according to the invention,

FIG. 4 is an enlarged view of FIG. 3,

FIG. 5 shows the reactivity of liquid silicon on a sacrificial layer of the pre-densified fibrous preform of FIG. 3,

FIG. 6 shows a schematic block diagram of the steps in a method for manufacturing a part in CMC material according to the invention.

The elements with the same functions in the different implementations have the same references in the figures.

### DETAILED DESCRIPTION OF THE INVENTION

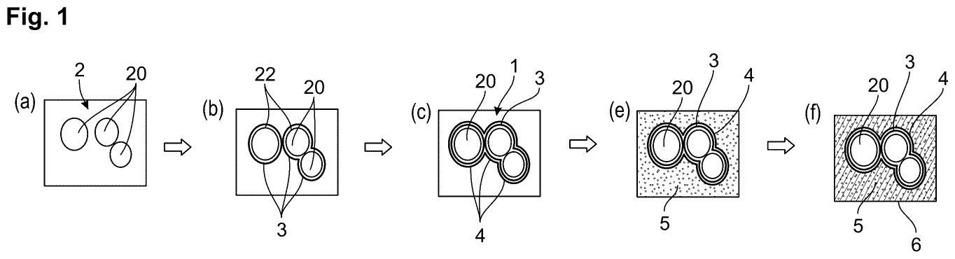

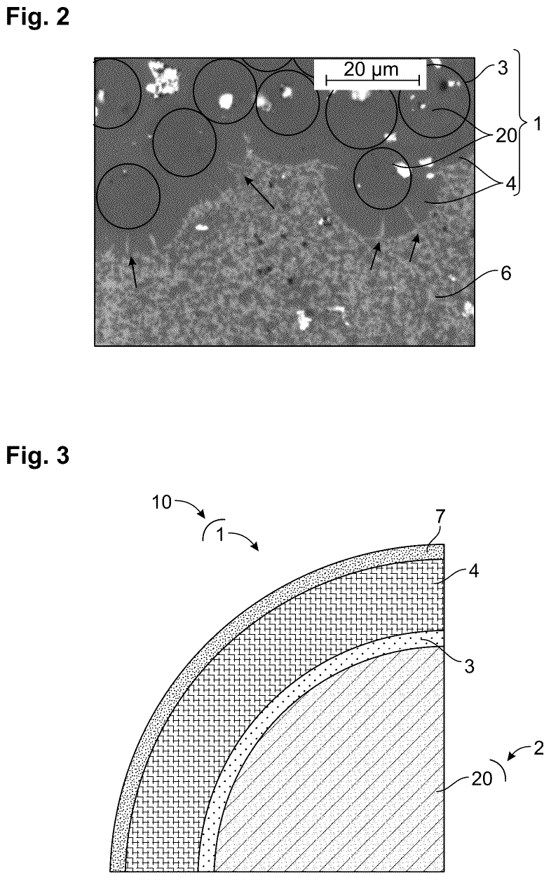

FIGS. 1 and 2 have been described in the technical background to the present invention and illustrate a fibrous preform for making a part made of a ceramic matrix composite (CMC), in particular one reinforced with silicon carbide (SIC), and its manufacturing method according to the prior art.

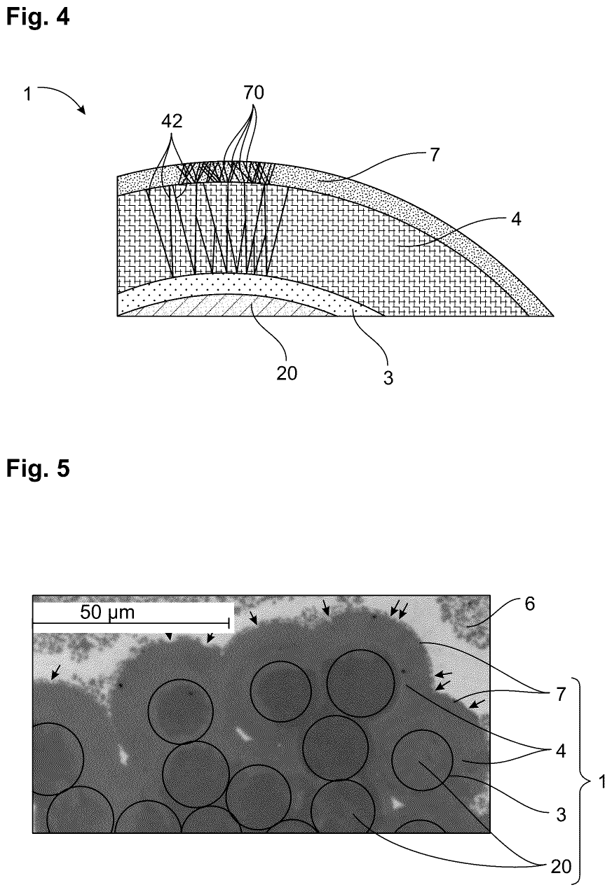

FIGS. 3 and 4 illustrate a fibrous preform 1 for producing a part made of CMC material 10.

The fibrous preform 1 according to the invention comprises:
a fibrous reinforcement 2,
at least one interphase layer 3,
at least one pre-densified layer 4, and
at least one sacrificial layer 7.

The fibrous reinforcement 2 may comprise ceramic fibers 20. For example, fibers 20 may comprise mainly silicon carbide (hereinafter referred to as SiC) or non-oxide ceramic fibers. SiC fibers marketed under the name “Hi-Nicalon S” can be used. Alternatively, carbon fiber can be used.

The fibrous reinforcement 2 can be in the form of a unidirectional (1D) texture such as a thread or a roving, or a bidirectional (2D) texture such as a unidirectional or multidirectional fabric or web, or even in the form of a three-dimensional (3D) texture such as a felt, fabric or knitted fabric; or even a 3D texture formed by winding or draping 1D or 2D textures. Preferably, the fibrous reinforcement has a deformable structure. The interphase layer 3 extends around a surface 22 of each of the fibers 20. In other words, the interphase layer 3 encases each fiber 20 of the fibrous reinforcement. As mentioned previously, this interphase layer optimises the bond between the fibers 20 and a matrix 6 of the part made of CMC material and deflects cracks (which may be generated within the matrix 6) that would propagate towards the fibers 20.

Preferably, the interphase layer 3 is based on boron nitride (BN). The boron nitride allows for good oxidation resistance and can be easily implemented.

Advantageously, the interphase layer 3 has a thickness of between 100 nm and 700 nm, preferably between 250 nm and 500 nm.

The pre-densified layer 4 extends over the interphase layer 3. The interphase layer 3 is inserted between the fiber 20 and the pre-densified layer 4. The pre-densified layer 4 can be made of ceramic, such as SiC, particularly when the fibers 20 are made of SiC or carbon.

This pre-densified layer 4 has a columnar microstructure composed in particular of SiC grains.

In the usual sense of the crystallographic field, a columnar microstructure is a microstructure in which the grains have an elongated columnar shape (e.g. cylindrical or any other non-cylindrical shape, such as truncated conical or trapezoidal), i.e. in which one direction is larger than the other two. In the present application, the largest grain direction of the columnar microstructure extends in a radial direction from the fiber 20 towards the pre-densified layer 4.

Such a columnar microstructure may be the result of a CVI method, which will be described below, and in particular of the growth of grains along a preferred crystallographic direction.

To ensure that the microstructure can be columnar, it is preferable for the pre-densified layer 4 to have a thickness of 3 μm or more.

Thus, the columnar, e.g. cylindrical, SiC grains in the pre-densified layer 4 may have a height (in the radial direction) greater than or equal to 3 μm. These cylindrical SiC grains can be between 0.2 μm and 1 μm wide.

In the present application, the “columnar” shape can be defined as an elongated shape extending mainly in one direction. The columnar shape may have two opposing bases which may or may not be parallel to each other, each with a circular, elliptical, prismatic and/or other cross-sectional shape. The columnar shape may have a constant or variable cross-section between its two bases. For example, the tubular shape may be cylindrical (in particular a straight cylinder), frustoconical, trapezoidal, prismatic, etc.

The “cylindrical” shape can be a straight cylinder with two opposite bases that are parallel to each other, each with a circular, elliptical, prismatic or other cross-sectional shape. The straight cylinder can have a constant cross-section between its two bases. The straight cylinder, for example, is a cylinder of revolution, with a constant diameter between its two bases.

Advantageously, the pre-densified layer 4 has a thickness of between 3 μm and 20 μm. This range of values allows to obtain a pre-densified layer with a columnar microstructure. Preferably, the thickness of the pre-densified layer is between 10 μm and 20 μm.

The sacrificial layer 7 is located on the pre-densified layer 4 and is preferably in direct contact with it. The sacrificial layer 7 can be made of ceramic, such as SiC, particularly when the pre-densified layer 4 is made of SiC.

The sacrificial layer 7 comprising SiC has grains with an average size of between 0.1 μm and 0.5 μm.

The sacrificial layer 7 may have a grain density (SIC) that is greater than a grain density (SIC) of the pre-densified layer 4. By way of example, the grain density of the sacrificial layer 7 is greater by a factor of between 20 and 40 than that of the pre-densified layer 4. In particular, this allows to obtain a fine-grained microstructure of the sacrificial layer 7 compared with the columnar microstructure of the pre-densified layer 4.

In addition, the density of SiC grains in the sacrificial layer 7, which is greater than that in the pre-densified layer 4, can enable the formation of micro-structured SiC grains 70 in the sacrificial layer 7 compared with the columnar SiC grains 42 in the pre-densified layer 4, as illustrated schematically in FIG. 4. The sacrificial layer 7 thus has a larger fine grain boundary surface area than the pre-densified layer, so that the liquid silicon reacts preferentially with the sacrificial layer 7 and the pre-densified layer 4 is therefore protected from attack by the liquid silicon. The sacrificial layer 7 can have a thickness of between 5% and 20% of the thickness of the pre-densified layer 4.

Advantageously, the thickness of the sacrificial layer 7 is between 1 μm and 4 μm. Preferably, the thickness of the sacrificial layer is between 1 μm and 2 μm. This allows a fine-grained joint surface to be reinforced so that the liquid silicon reacts with the carbon in the sacrificial layer 7.

By way of example, the thickness of the various layers of the fibrous preform 1 (such as the interphase layer 3, the pre-densified layer 4 and the sacrificial layer 7) can be measured by TEM or scanning electron microscopy. The grain size, particularly of the sacrificial layer 7 and the pre-densified layer 4, can be measured by transmission electron microscopy. The density of the grains, particularly the sacrificial layer 7 and the pre-densified layer 4, can also be measured by transmission electron microscopy or Raman spectroscopy. The crystalline orientation and general structure (or difference in structure) of the SiC grains in the pre-densified layer 4 and sacrificial layer 7 can be determined by transmission electron microscopy or Raman spectroscopy.

The columnar microstructure of the pre-densified layer 4 may have columnar silicon carbide grains (e.g. generally cylindrical or frustoconical) with a first form factor. The first form factor of the SiC grains can be greater than or equal to 10. Preferably, the first form factor can be greater than or equal to 20.

The SIC grains in the sacrificial layer 7 may have a second form factor. The second form factor of the SiC grains can be less than or equal to 5. Preferably, the second form factor can be less than or equal to 2.

The first form factor of the SiC grains is greater than the second form factor of the SiC grains.

As previously stated, the form factor of a SIC grain is defined as the ratio of its largest dimension to its smallest dimension. In the case of a columnar microstructure with rotationally cylindrical SiC grains, the largest dimension of a SiC grain corresponds to the height of the cylinder and its smallest dimension corresponds to its diameter. In the present application, the first and second form factors of the SIC grains may represent an average of the form factors of the SiC grains making up, respectively, the pre-densified layer 4 and the sacrificial layer 7.

The fibrous preform 1 may comprise several sacrificial layers 7 superimposed on one another and extending over the pre-densified layer 4. The number of sacrificial layers 7 can be up to five. This increases the surface area of the sacrificial layer and further blocks the attack of liquid silicon on the pre-densified layer. In the example shown in FIGS. 3 and 4, a single sacrificial layer 7 coats the pre-densified layer 4.

FIG. 5 illustrates an example of the fibrous preform 1 according to the invention, in which the sacrificial layer 7 can be seen to have degraded, while the pre-densified layer 4 (as well as the interphase layer 4 and the fibers 20) remain intact. The etching of this sacrificial layer 7 by the liquid silicon is marked by arrows in FIG. 5. Since FIG. 5 shows that no cracks propagate in the pre-densified layer 4, unlike those in the prior art (FIG. 2), it can be concluded that a sacrificial layer 7 protects the pre-densified layer 4 from attack by liquid silicon during the method of making the part from CMC material.

The invention also relates to a part 10 made of CMC material comprising the fibrous preform 1 described above with reference to FIGS. 3 to 5, and a densified ceramic matrix 6.

The part 10 may be a part of a turbomachine, in particular an aircraft. By way of example, this turbomachine part is a vane of a turbine or compressor of the turbomachine, an annular wall of a combustion chamber of the turbomachine, etc.

Advantageously, the matrix 6 is based on silicon carbide, particularly when the fibers 20 are made of SiC or carbon.

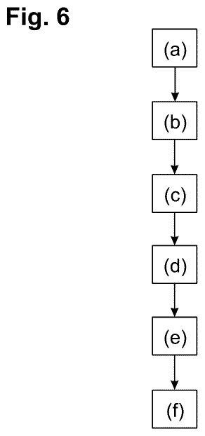

With reference to FIG. 6, this application will now describe an example of a manufacturing method for the fibrous preform 1 and also for the CMC material part 10.

The method of manufacturing the fibrous preform 1 comprises the steps of:
(a) obtaining the fibrous reinforcement 2 comprising SiC-based fibers 20,
(b) forming the interphase layer 3 on each of the surfaces 22 of the SiC-based fibers 20,
(c) forming the SiC-based pre-densified layer 4 on the interphase layer 3 by chemical vapour infiltration (CVI), and
(d) depositing at least one SiC-based sacrificial layer 7 on the pre-densified layer 4 of step (c) by chemical vapour infiltration (CVI), to obtain the fibrous preform 1 in particular which is partially pre-densified.

The fibrous reinforcement 2 in step (a) may have a shape close to that of the part to be manufactured. As described above, the fibrous reinforcement 2 can be obtained by multi-layer or 3D weaving from threads or rovings. It is also possible to start from a 2D texture, such as a fabric or a sheet of threads or rovings, to form layers which will then be draped over a shape and possibly linked together, for example by sewing or implanting threads.

For example, the interphase layer 3 can also be deposited by chemical vapour infiltration (CVI).

The CVI deposition technique is well known. Reference may be made, for example, to the document FR-A1-2 742 433.

The CVI deposition in step (c) can be carried out using a first gas mixture comprising methyltrichlorosilane (MTS) and dihydrogen (H₂) as reactive species. The volume ratio of dihydrogen to methyltrichlorosilane can be between 5 and 15. In other words, the proportion by volume of H₂ can be between 83% and 94% and the proportion by volume of MTS can be between 17% and 6%, respectively. In particular, this allows to form SIC columnar (or in other words, generally cylindrical or frustoconical) grains in the pre-densified layer 4.

To carry out the CVI deposition of the pre-densified layer 4, at least one of the parameters below may be chosen from:
a number of deposition cycles equal to one,
a first pressure of the first gas mixture of between 70 mbar and 150 mbar,
a first temperature of the first gas mixture of between 900° C. and 1100° C., and
an initial period of between 10 and 30 hours.

The CVI deposit in step (d) can be produced from a second gas mixture comprising of methyltrichlorosilane (MTS) and dihydrogen (H₂). A proportion by volume of H₂ can be between 15% and 30% and the proportion by volume of MTS can be between 85% and 70%, respectively. In particular, this allows to form microstructured SiC grains (or in other words, generally granular or spherical) in the sacrificial layer 7.

For the CVI deposition of the sacrificial layer or layers 7, at least one of the parameters below may be chosen from:
a number of deposit cycle(s) of between one and ten,
a second pressure of between 70 mbar and 150 mbar,
a second temperature of between 900° C. and 1100° C., and
a second duration of between 30 minutes and 3 hours.

Advantageously, a first parameter that can be used to differentiate the formation of the pre-densified layer 4 and the sacrificial layer 7 is the volume ratio of the reactive species MTS and H₂. As described above, the proportion by volume of H₂ may be between 83% and 94% and the proportion by volume of MTS may be between 17% and 6%, respectively, to form the pre-densified layer 4, and the proportion by volume of H₂ may be between 15% and 30% and the proportion by volume of MTS may be between 85% and 70%, respectively, to form the sacrificial layer 7.

A second parameter that can allow to differentiate between the formation of the pre-densified layer 4 and the sacrificial layer 7 is related to the conditions of the environment at the time of resumption of growth of the SiC grains, with the same volume proportions of MTS and H₂, and the same conditions of temperature, flow rate and pressure. Local supersaturation promotes the germination of SiC grains during CVI deposition. Such local supersaturation is observed, for example, following a break in the deposition cycle. The length of the CVI deposit cycles therefore influences the structure of the deposit. Short cycles favour the formation of SiC grains (and therefore the formation of the sacrificial layer 7), and longer cycles favour the formation of columnar SiC grains (and therefore the formation of the pre-densified layer 4).

In a first embodiment, the CVI deposit in step (d) is carried out in conventional mode. To achieve this, the CVI deposit can be made by voluntarily stopping the supply of reactive gas flow (i.e. the MTS), then re-supplying the reactive gas, for example for a period of between 30 minutes and 3 hours.

The second gas mixture comprises a higher proportion of methyltrichlorosilane than dihydrogen. Preferably, the proportion of methyltrichlorosilane and dihydrogen is between 70/30 and 85/15 by volume. In particular, this proportion allows to obtain the aforementioned SiC grain size and/or density of the sacrificial layer 7. Advantageously, these proportions allow to generate an excess of carbon in the sacrificial layer.

The first and second pressures can be identical.

According to a second embodiment, the CVI deposition in step (d) is carried out in pulsed mode. The pulsed mode can be achieved by multiple stops and returns of reagent gas over a predetermined time interval (such as 30 minutes to 3 hours) to produce the sacrificial layer. In particular, this pulsed mode increases the concentration of SIC fine grain microstructure in the sacrificial layer 7. In addition, the pulsed mode allows precise control of the microstructure of the sacrificial layer deposits formed. To this end, and in a non-limiting manner, the fibrous reinforcement 1 is placed in an enclosure (not illustrated in the figures) where the aforementioned temperature and pressure conditions are established. A volume of the reaction gas phase depositing the sacrificial layer 7 is admitted into the enclosure and remains there for the aforementioned time, before the gaseous species are evacuated from the enclosure and a new volume of gas phase is introduced. The cycle comprising the introduction of the gaseous phase into the enclosure, the residence of the gaseous phase inside the enclosure and the evacuation of the gaseous species from the enclosure is repeated the number of times necessary to achieve the desired sacrificial layer deposition thickness.

Step (d), and in particular the second duration of this step (d), may comprise at least two successive cycles, preferably between two and ten cycles. Each cycle can last between 3 and 18 minutes. The second duration of step (d) then corresponds to the cumulative duration of the various cycles during which the second gas mixture is deposited by chemical vapour infiltration.

The second gas mixture can have a methyltrichlorosilane content of between 70% and 85% by volume and a dihydrogen content of between 15% and 30% by volume. The first gas mixture can have a methyltrichlorosilane content of between 6% and 17% by volume and a dihydrogen content of between 94% and 83% by volume.

The first and second pressures can be identical.

With reference to FIG. 6, the process may comprise a step (e) of incorporating a powder 5 into the fibrous preform 1 obtained in step (d). Preferably, the powder 5 can be a silicon carbide SiC powder.

The fibrous preform 1 from step (d) or step (e), which is partially densified and porous, can be further densified by an MI-type process. To do this, a step (f) of densifying this consolidated fibrous preform 1 can be carried out by impregnating it with a liquid or molten ceramic matrix 6 to form the part made of CMC material 10. Preferably, the matrix 6 is based on silicon carbide.

1. A fibrous preform for producing a part made of ceramic matrix composite material, the fibrous preform comprising:
a fibrous reinforcement comprising fibers based on silicon carbide (SiC);
an interphase layer extending around a surface of each of the fibers based on silicon carbide, wherein the interphase layer is based on boron nitride;
a pre-densified layer comprising silicon carbide (SiC), the pre-densified layer being located on the interphase layer and having a columnar microstructure, the pre-densified layer having a thickness of between 3 μm and 20 μm; and
at least one a sacrificial layer located on the pre-densified layer, the sacrificial layer comprising silicon carbide having grains with an average size of between 0.1 μm and 0.5 μm.

2. The fibrous preform according to claim 1, wherein the at least one sacrificial layer has a grain density greater than that of the pre-densified layer by a factor of between 20 and 40.

3. The fibrous preform according to claim 1, wherein the at least one sacrificial layer has a thickness between 1 and 4 μm.

4. The fibrous preform according to claim 1, wherein several sacrificial layers are superimposed on one another and extend over the pre-densified layer, and wherein the number of the several sacrificial layers is five or fewer.

5. The fibrous preform according to claim 1, wherein the columnar microstructure of the pre-densified layer has silicon carbide grains in columnar form having a height which is greater than or equal to 3 μm and/or a width of between 0.2 μm and 1 μm.

6. The fibrous preform according to claim 1, wherein the columnar microstructure of the pre-densified layer has silicon carbide grains having a form factor strictly greater than a form factor of the silicon carbide grains of the at least one sacrificial layer.

7. The fibrous preform according to claim 6, wherein the form factor of the silicon carbide grains of the pre-densified layer is greater than or equal to 10, and wherein the form factor of the silicon carbide grains of the at least one sacrificial layer is less than or equal to 5.

8. The fibrous preform according to claim 1, wherein the at least one sacrificial layer has a thickness representing between 5% and 20% of the thickness of the pre-densified layer.

9. A ceramic matrix composite material part comprising:
a fibrous preform according to claim 1; and
a densified ceramic matrix, the densified ceramic matrix being based on silicon carbide (SiC).

10. A method for manufacturing a fibrous preform according to claim 1, the fibrous preform being configured to produce a part made of ceramic matrix composite material, the method comprising:
(a) obtaining the fibrous reinforcement comprising fibers based on silicon carbide,
(b) forming the interphase layer on each of the surfaces of the fibers based on silicon carbide,
(c) forming the pre-densified layer on the interphase layer by chemical vapour infiltration (CVI), and
(d) depositing at least one silicon carbide-based sacrificial layer on the pre-densified layer formed in step (c) by chemical vapour infiltration (CVI) to form the fibrous preform.

11. The method according to claim 10, wherein the chemical vapour infiltration (CVI) of step (c) is carried out by a first gas mixture comprising methyltrichlorosilane (MTS) and dihydrogen (H₂), in a volume ratio of dihydrogen to methyltrichlorosilane of between 5 and 15, at a first pressure of between 70 mbar and 150 mbar, and for a first duration of between 10 hours and 30 hours, and
wherein the chemical vapour infiltration of step (d) is carried out by a second gas mixture comprising methyltrichlorosilane (MTS) and dihydrogen (H₂) at a second pressure identical to the first pressure and for a second duration of between 30 minutes and 3 hours.

12. The method according to claim 11, wherein, in step (d), the second gas mixture comprises a higher proportion of methyltrichlorosilane (MTS) than of dihydrogen (H₂), preferably the proportion of methyltrichlorosilane and dihydrogen (H2) is between 70/30 and 85/15 by volume, and wherein the first and second predetermined pressures are identical.

13. The method according to claim 11, wherein step comprises between two and ten cycles, each of the cycles having a duration of between 3 and 18 minutes.

14. The method according to claim 10, further comprising a step (e) of incorporating a mixture of silicon carbide powders into the fibrous preform formed in step.

15. A method of manufacturing a part made of ceramic matrix composite material the method being comprising the steps (a) to (e) of the method of manufacturing a fibrous preform according to claim 14, and further comprising a step (f) of densifying the fibrous preform formed in step (e) by infiltration of a silicon-based molten ceramic matrix to form the part of composite material having a ceramic matrix.
